(19) United States
(12) Patent Application Publication
(10) Pub. No.: US 2025/0384857 A1
(43) Pub. Date: Dec. 18, 2025

(54) CONVERSION DEVICE AND METHOD FOR AUTOMATICALLY SELECTING EXTENDED DISPLAY IDENTIFICATION DATA

(71) Applicant: AVerMedia TECHNOLOGIES, INC., New Taipei City (TW)

(72) Inventors: Yen Cheng YAO, New Taipei City (TW); Chia-Jung HSIAO, New Taipei City (TW); Wen-Chien CHANG, New Taipei City (TW)

(21) Appl. No.: 19/237,011

(22) Filed: Jun. 13, 2025

(30) Foreign Application Priority Data
Jun. 14, 2024 (TW) 113122189

(51) Int. Cl. G09G 5/00; G09G 5/10

(52) U.S. Cl. CPC G09G 5/006; G09G 5/10; G09G 2340/0435; G09G 2354/00; G09G 2370/042; G09G 2370/22

(57) ABSTRACT

A method for automatically selecting extended display identification data (EDID) includes steps as follows. The extended display identification data of an external device is obtained through a conversion device; the conversion device is based on the extended display identification data of the external device to determine the version of a connection interface of the external device; the conversion device is based on the version of the connection interface of the external device to select a corresponding extended display identification data; the conversion device notifies a signal source device to obtain the corresponding extended display identification data.

### RELATED APPLICATIONS

This application claims priority to Taiwan Application Serial Number 113122189, filed Jun. 14, 2024, which is herein incorporated by reference.

### BACKGROUND

### Technical Field

The present disclosure relates to an electronic device and operation method thereof, and more particularly to a conversion device and a method for automatically selecting extended display identification data (EDID).

### Description of Related Art

Commercial audio and video transmission interfaces, such as high-definition multimedia interface (HDMI), have multiple versions ranging from HDMI 1.4 to HDMI 2.1. With technological advancements and specific application scenarios, the use of peripheral or conversion devices between audio/video source devices and audio/video sink devices has become increasingly common. However, improper selection or mismatched combinations may lead to compatibility issues. For example, if a peripheral or conversion device utilizes a newer version of the extended display identification data (EDID), some video/audio source devices with an older HDMI 1.4 version attempting to read the EDID of video/audio sink devices with newer HDMI 2.0 version may have compatibility problems, such as resolution down to 480P, no sound, or no picture.

A common solution is to allow users to manually select the EDID version of the video/audio sink device. However, most users do not know how to make the appropriate selection, which may lead to difficulties in using the product.

In order to address the aforementioned issue, considerable effort has been devoted within the relevant field to seeking viable solutions. However, a suitable approach has yet to be developed. Therefore, how to automatically select the EDID more efficiently is one of the most important research and development issues, and has become the goal of improvement in the relevant field.

### SUMMARY

The disclosure provides a conversion device and a method for automatically selecting extended display identification data (EDID) to improve the problems of prior art.

According to some embodiments of the disclosure, the conversion device includes a transmission module, a processing module, and a receiving module. The transmission module is electrically connected to the processing module, and the processing module is electrically connected to the receiving module. When the transmission module detects that an external device is connected, the transmission module obtains an extended display identification data of an external device. The processing module determines a version of a connection interface of the external device based on the extended display identification data of the external device. The processing module selects a corresponding extended display identification data based on the version of the connection interface of the external device. The receiving module transmits a connection signal to a signal source device to notify the signal source device to obtain the corresponding extended display identification data.

According to an embodiment of the disclosure, the method for automatically selecting extended display identification data includes obtaining an extended display identification data of an external device through a conversion device; determining a version of a connection interface of the external device through the conversion device based on the extended display identification data of the external device; selecting a corresponding extended display identification data through the conversion device based on the version of the connection interface of the external device; and notifying a signal source device through the conversion device to obtain the corresponding extended display identification data.

In summary, the technical solution of the present disclosure offers significant advantages and beneficial effects compared to the prior art. By using the proposed conversion device and the method for automatically selecting the extended display identification data, the appropriate extended display identification data (i.e., the corresponding extended display identification data as described above) can be determined for the user. This allows the conversion device to function properly without manual settings, so as to avoid complicated user settings and thereby improves the user-friendliness of the conversion device.

The following is a detailed description of the above description by way of implementation and provides further explanation of the technical solutions of the disclosure.

### BRIEF DESCRIPTION OF THE DRAWINGS

In order to make the above and other features, advantages and embodiments of the disclosure easier to understand, the accompanying drawings are described as follows.

FIG. 1 is a block diagram showing a conversion device in accordance with some embodiments of the present disclosure.

FIG. 2 is a flow chart of a method for automatically selecting extended display identification data (EDID) in accordance with some embodiments of the present disclosure.

FIG. 3 is a flow chart of a method for automatically selecting extended display identification data in accordance with some embodiments of the present disclosure.

### DETAILED DESCRIPTION

In order to make the description of the present disclosure more detailed and complete, reference may be made to the accompanying drawings and the various embodiments described below. The same numbers in the drawings represent the same or similar components. On the other hand, well known components and steps are not described in the embodiments to avoid unnecessary limitation of the present disclosure.

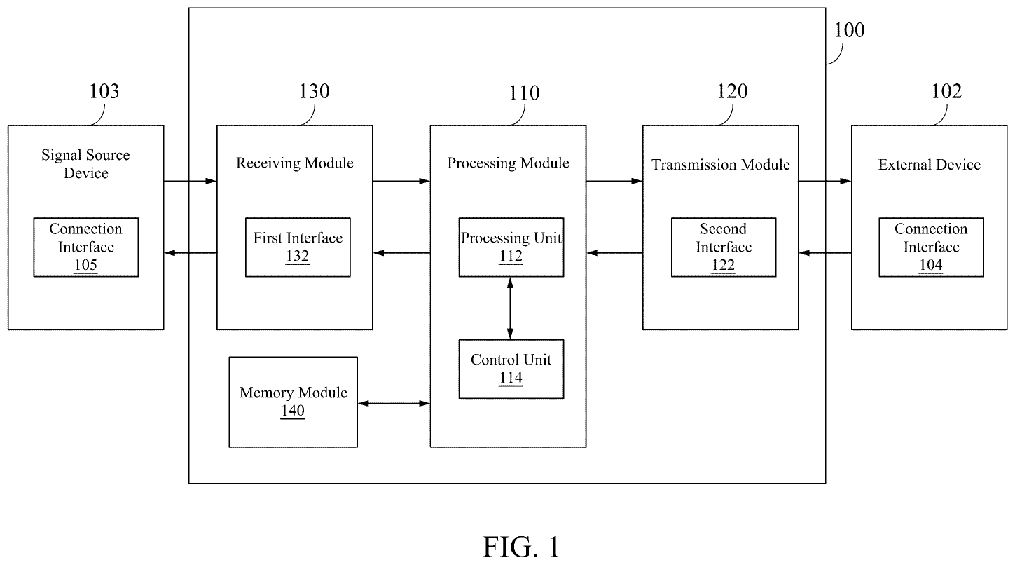

FIG. 1 is a block diagram showing a conversion device 100 in accordance with some embodiments of the present disclosure. The conversion device 100 may be connected to a signal source device 103 and an external device 102. In use, the conversion device 100 is used to convert videos or/and sounds. For example, the conversion device 100 may be an audio/video capture device (e.g., an audio/video capture card, or a capture box), a signal converter, a signal splitter (KVM), or other similar devices.

Regarding the specific architecture of the conversion device 100, as shown in FIG. 1, the conversion device 100 may include a processing module 110, a transmission module 120, a receiving module 130, and a memory module 140. Architecturally, the processing module 110 is electrically connected to the transmission module 120, the receiving module 130, and the memory module 140.

In use, when the transmission module 120 detects that there is an external device 102 connected, the transmission module 120 obtains an extended display identification data of the external device 102. The processing module 110 determines the version of the connection interface 104 of the external device 102 based on the extended display identification data of the external device 102, and selects a corresponding extended display identification data based on the version of the connection interface 104 of the external device 102. The receiving module 130 transmits a connection signal to the signal source device 103 to notify the signal source device 103 to obtain the corresponding extended display identification data described above.

Therefore, the conversion device 100 automatically determines the extended display identification data (i.e., the corresponding extended display identification data described above) that is usable for the user, allowing the user to operate the conversion device 100 normally without manual settings, so as to avoid complicated user settings and thereby improves the user-friendliness of the conversion device 100.

With respect to the above mechanism for determining the version of the connection interface 104, in some embodiments of the present disclosure, the processing module 110 analyzes the information (e.g., resolution, vendor name and serial number) of the extended display identification data of the external device 102 to determine whether the memory module 140 includes any records of the external device 102 (i.e., analysis log information). If there is a record, the processing module 110 uses the previously recorded version as the version of the connection interface 104 for the external device 102. If there is no record, the processing module 110 analyzes the contents of the extended display identification data of the external device 102 to determine the version of the connection interface 104 to which the extended display identification data of the external device 102 matches.

For example, the memory module 140 stores analysis log information, which may record the version of the connection interface 104 to which the extended display identification data of the external device 102 matches, and may also record the correspondence relationship between the version of the connection interface 104 and the information (e.g., resolution, vendor name and serial number) of the extended display identification data of the external device 102. If the conversion device 100 and the external device 102 are reconnected at the next time, the processing module 110 may analyze the aforementioned information of the extended display identification data of the external device 102 and uses the previously recorded version as the version of the connection interface 104 for the external device 102.

Regarding the selection mechanism of the corresponding extended display identification data mentioned above, in some embodiments of the present disclosure, the memory module 140 stores multiple built-in extended display identification data. The processing module 110 integrates the extended display identification data of the external device 102 with one of the built-in extended display identification data corresponding to the version of the connection interface 104, thereby generating the corresponding extended display identification data. This corresponding extended display identification data matches the video and audio signal receiving capabilities of both the conversion device 100 and the external device 102, thereby avoiding compatibility issues.

For example, the memory module 140 stores the extended display identification data of the external device 102 and the integrated corresponding extended display identification data, and the processing module 110 may store the integrated corresponding extended display identification data as an additional built-in extended display identification data in the memory module 140.

In some embodiments of the present disclosure, the processing module 110 selects a built-in extended display identification data (e.g., the integrated corresponding extended display identification data from previous records) from the memory module 140 that corresponds to the version of the connection interface 104 to serve as the corresponding extended display identification data.

Regarding the connection signal generation mechanism mentioned above, the processing module 110 generates a hot-plugging signal as the connection signal. The processing module 110 then sends the hot-plugging signal to the signal source device 103 for notifying the signal source device 103 to reconnect to the first interface 132 of the receiving module 130, thereby obtaining the corresponding extended display identification data. Thus, the user does not need to unplug and plug the signal source device 103 manually, and the signal source device 103 automatically recognizes compatible video and/or audio signals based on the corresponding extended display identification data.

Regarding the specific architecture of the receiving module 130, for example, the receiving module 130 may be a receiver for receiving a video/audio source. The aforementioned receiver may be an audio/video receiver, such as an HDMI receiver, a DP receiver, a DVI receiver, or a receiving device with EDID. Alternatively, the receiving module 130 may be a transceiver.

The receiving module 130 may include a first interface 132, which may be an audio/video transmission interface, such as a high-definition multimedia interface (HDMI), a display port (DP), or a digital video interface (DVI). Some embodiments of the present disclosure are exemplified by a high-definition multimedia interface (HDMI). In use, the receiving module 130 may be used to transmit video or audio signals, connection signals (e.g., hot-plugging signals), and data (e.g., EDID).

For example, the first interface 132 of the receiving module 130 and the connection interface 105 of the signal source device 103 both support a video or audio transmission channel (unidirectional), a signal transmission channel (unidirectional), and a data communication channel (bidirectional).

In some embodiments of the present disclosure, the receiving module 130 further includes a storage module (e.g., a flash memory, an electronic erasable rewritable read-only memory), which is used to store the corresponding extended display identification data (EDID) selected by the processing module 110. Alternatively, in some embodiments of the present disclosure, the corresponding extended display identification data (EDID) may be stored in the processing module 110 or the memory module 140.

Regarding the specific mechanism of the processing module 110 mentioned above, the processing module 110 is used to analyze the EDID of the external device 102 to determine the version of the connection interface 104 to which the EDID of the external device 102 belongs to. Based on the determined version of the connection interface 104, the processing module 110 selects the corresponding EDID associated with that version of the connection interface 104. Furthermore, the processing module 110 is capable of performing EDID integration (Merger), which integrates the EDID of the external device 102 with the built-in EDID of the corresponding version in the conversion device 100. As a result, an integrated corresponding EDID that matches the video and audio signal receiving capabilities of both the conversion device 100 and the external device 102 is generated. For example, the processing module 110 may be a processor, a microcontroller unit (MCU), a system-on-chip (SoC), a field-programmable gate array (FPGA), or a processing circuit. Alternatively, the processing module 110 may be implemented using hardware, software, firmware, or any combination thereof.

In some embodiments of the present disclosure, the processing module 110 further includes a processing unit 112 and a control unit 114.

For example, the processing unit 112 may be a computational processing unit such as a processor, a microcontroller unit (MCU), a system-on-chip (SoC), a field-programmable gate array (FPGA), an advanced reduced instruction set machines (ARM), or a central processing unit (CPU).

In use, the processing unit 112 is used to analyze the version of the connection interface 104 to which the EDID of the external device 102 belongs to, extract related information (e.g., resolution, vendor name and serial number), and perform the EDID integration function.

For example, the control unit 114 may be a controller for data transmission, such as a microcontroller, a system-on-chip (SoC), or a control circuit.

In use, the control unit 114 is configured to control the transmission module 120 to read the EDID of the external device 102 to the processing unit 112, and to access the data of the memory module 140 to control the receiving module 130 to restart the EDID setting process for EDID configuration.

Regarding the hardware architecture of the memory module 140 mentioned above, the memory module 140 may be a NOR-type flash memory, a NAND-type flash memory, an electrically erasable programmable read-only memory (EEPROM), a random access memory (RAM), or other storage media.

In use, the memory module 140 is configured to store multiple built-in EDIDs, such as EDIDs of different interface types and versions, and integrated corresponding EDIDs. In some embodiments of the present disclosure, the memory module 140 may be disposed within the processing module 110, or may be disposed separately from the processing module 110. The memory module 140 and the processing module 110 operate cooperatively when performing EDID integration.

Regarding the hardware architecture of the transmission module 120 mentioned above, the transmission module 120 outputs audio and video sources. The transmission module 120 may be a transmitter, such as an audio/video transmitter (e.g., a HDMI transmitter, a DP transmitter, and a DVI transmitter). Alternatively, the transmission module 120 may also be a transceiver.

In some embodiments of the present disclosure, the transmission module 120 may include a second interface 122. In use, the second interface 122 is used to transmit video or audio signals, connection signals (e.g., hot-plugging signals), and data (e.g., EDID).

Regarding the hardware architecture of the signal source device 103 mentioned above, the signal source device 103 may be, for example, a camera, a video game console (e.g., PS5), a handheld game console (e.g., Switch), a computer, or other audio/video output devices.

Regarding the hardware architecture of the external device 102 mentioned above, the external device 102 may be a video and/or audio receiving device configured to receive video and/or audio. For example, the external device 102 may be a display, a television, a speaker (e.g., a sound bar, or an amplifier), another computing device (e.g., hardware configured to perform audio/video processing or computing), or any combination thereof.

In some embodiments of the present disclosure, the receiving module 130, the memory module 140, the processing module 110, and the transmission module 120 may be implemented as separate components (e.g., circuits), or partially or entirely integrated within a single SoC.

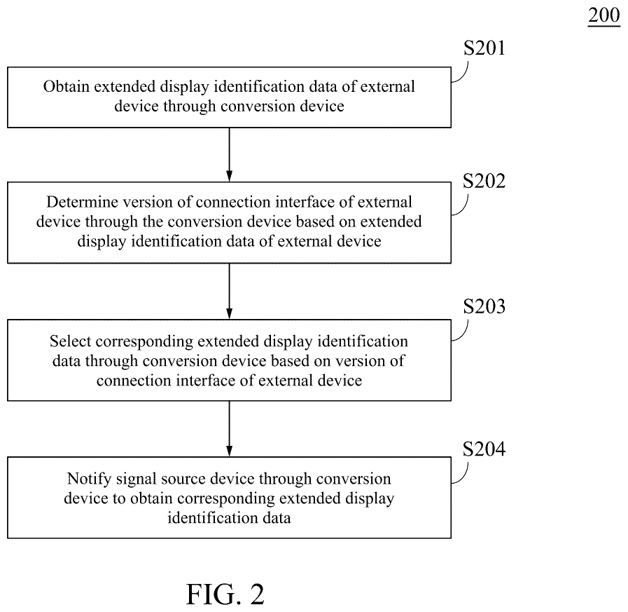

To further describe the operation method of the conversion device 100, please refer to FIGS. 1 and 2 concurrently. FIG. 2 is a flowchart of a method 200 for automatically selecting extended display identification data in accordance with some embodiments of the present disclosure. It should be understood that, in the embodiment shown in FIG. 2, unless otherwise specified, the steps may be rearranged in order depending on practical needs, and may even be performed simultaneously or partially simultaneously.

At step S201, the conversion device 100 obtains the extended display identification data of the external device 102. At step S202, based on the extended display identification data of the external device 102, the conversion device 100 determines the version of the connection interface 104 of the external device 102. At step S203, based on the determined version of the connection interface 104, the conversion device 100 selects a corresponding extended display identification data. At step S204, the conversion device 100 notifies the signal source device 103 to obtain the corresponding extended display identification data.

As a result, the method 200 for automatically selecting extended display identification data automatically determines extended display identification data (i.e., the corresponding extended display identification data mentioned above) that is usable for the user, allowing the user to operate the conversion device 100 normally without manual settings, so as to avoid complicated user settings and thereby improves the user-friendliness of the conversion device 100.

In some embodiments of the present disclosure, at step S202, the conversion device 100 analyzes the information (e.g., resolution, vendor name and serial number) of extended display identification data of the external device 102 to determine whether there is a record of the external device 102. If there is a record, the conversion device 100 uses the previously recorded version as the version of the connection interface 104 for the external device 102. If there is no record, the conversion device 100 analyzes the contents of the extended display identification data of the external device 102 to determine the version of the connection interface 104 to which the extended display identification data of the external device 102 matches.

Specifically, at step S202, the conversion device 100 analyzes the maximum value of a pixel clock, audio and video functions, high dynamic range imaging (HDR) information, and vendor specific data block (VSDB) data or field information in the extended display identification data of the external device 102, in order to determine the version of the connection interface 104 to which the extended display identification data of the external device 102 matches.

For example, the maximum value of the pixel clock in HDMI 2.1 is 1200 MHz, the audio and video functions of HDMI 2.1 include an auto low latency mode, quick frame transport, quick media switching, variable refresh rate, and resolution identification, HDMI 2.1 supports dynamic HDR, and the identifier of the vendor specific data block in HDMI 2.1 is C45DD8. For example, the maximum value of the pixel clock in HDMI 1.4 is 340 MHZ, HDMI 1.4 has no additional audio or video functions, HDMI 1.4 does not support HDR, and the identifier of the vendor specific data block in HDMI 1.4 is 000C03. Accordingly, the conversion device 100 may analyze the above contents in the extended display identification data of the external device 102 to determine the version of the connection interface 104 to which the extended display identification data of the external device 102 matches (e.g., HDMI 2.1 or HDMI 1.4).

In some embodiments of the present disclosure, at step S203, the conversion device 100 integrates the extended display identification data of the external device 102 with one of the multiple built-in extended display identification data corresponding to the version of the connection interface 104, thereby obtaining the corresponding extended display identification data.

Specifically, at step S203, the conversion device 100 intersects the extended display identification data of the external device 102 with one of the multiple built-in extended display identification data corresponding to the version of the connection interface 104 to obtain the corresponding extended display identification data. This corresponding extended display identification data matches the video and audio signal reception capabilities of both the conversion device 100 and the external device 102, thereby avoiding compatibility issues.

For example, the conversion device 100 analyzes the resolutions supported by itself and the resolutions supported by the external device 102, compares the data to extract their intersection, and retains the resolutions that are supported by both the conversion device 100 and the external device 102. This prevents compatibility issues such as the screen of the external device 102 being able to display a resolution that the conversion device 100 cannot capture, or the conversion device 100 being able to capture a resolution that the screen of the external device 102 cannot display.

The conversion device 100 stores the extended display identification data of the external device 102 and the integrated corresponding extended display identification data into the memory module 140. The integrated corresponding extended display identification data may be used as a new built-in extended display identification data, and analysis log information is recorded. The analysis log information may record, for example, the version of the connection interface 104 that corresponds to the extended display identification data of the external device 102, and may also record the correspondence relationship between the version of the connection interface 104 and the information (e.g., resolution, vendor name and serial number) of the extended display identification data of the external device 102. If the conversion device 100 and the external device 102 are reconnected, the conversion device 100 may analyze the aforementioned information of the extended display identification data of the external device 102 and uses the previously recorded version as the version of the connection interface 104 for the external device 102.

In some embodiments of the present disclosure, at step S203, the conversion device 100 selects the built-in extended display identification data corresponding to the version of the connection interface 104 (e.g., the integrated corresponding extended display identification data in previously records) to serve as the corresponding extended display identification data.

In some embodiments of the present disclosure, at step S204, the conversion device 100 sends a hot-plugging signal to the signal source device 103 to notify the signal source device 103 to reconnect to the conversion device 100, thereby obtaining the corresponding extended display identification data. Thus, the user does not need to manually unplug and plug the signal source device 103 manually, and the signal source device 103 automatically recognizes compatible video and/or audio signals based on the corresponding extended display identification data.

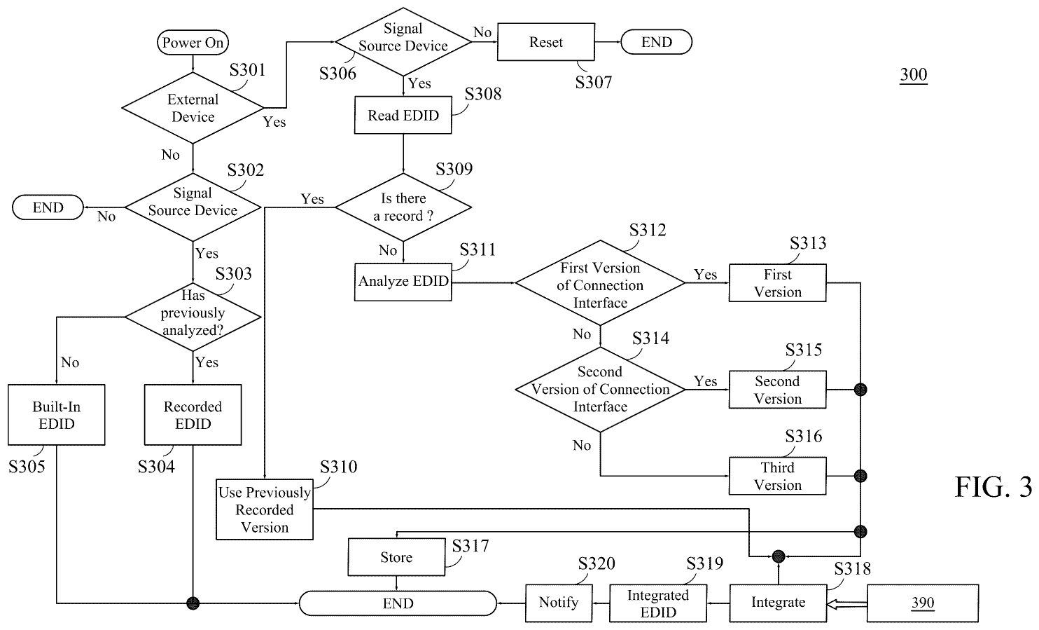

Please refer to FIGS. 1 and 3 concurrently, FIG. 3 is a flow chart of a method 300 for automatically selecting extended display identification data in accordance with some embodiments of the present disclosure. It should be understood that, in the embodiment shown in FIG. 3, unless otherwise specified, the steps may be rearranged in order depending on practical needs, and may even be performed simultaneously or partially simultaneously.

In the method 300 for automatically selecting extended display identification data, the conversion device 100 pre-stores a default extended display identification data table (default EDID table) 390. The default extended display identification data table 390 records multiple built-in extended display identification data corresponding to multiple versions of at least one connection interface.

After the conversion device 100 is powered on, at step S301, the conversion device 100 determines whether it is connected to the external device 102. If the conversion device 100 is not connected to the external device 102, at step S302, the conversion device 100 determines whether it is connected to the signal source device 103. If the conversion device 100 is connected to neither the signal source device 103 nor the external device 102, the conversion device 100 is inactive, and the method 300 for automatically selecting extended display identification data ends.

If the conversion device 100 is connected to the signal source device 103 but not connected to the external device 102, then at step S303, the conversion device 100 determines whether it has previously analyzed the extended display identification data (EDID) of the external device 102.

If the conversion device 100 has previously analyzed the extended display identification data of the external device 102, then at step S304, the conversion device 100 uses the recorded extended display identification data (e.g., the integrated corresponding extended display identification data in previous records) as the default extended display identification data provided to the signal source device 103.

Conversely, if the conversion device 100 has not previously analyzed the extended display identification data of the external device 102, then at step S305, the conversion device 100 uses a built-in extended display identification data (e.g., one of the built-in extended display identification data in the default extended display identification data table 390) as the default extended display identification data provided to the signal source device 103 (e.g., HDMI 2.1).

On the other hand, if the conversion device 100 is connected to the external device 102, then at step S306, the conversion device 100 determines whether it is also connected to the signal source device 103.

If the conversion device 100 is not connected to the signal source device 103 but is connected to the external device 102, then at step S307, the conversion device 100 may optionally clear the analysis log information of the extended display identification data, and reset the extended display identification data to the default extended display identification data.

If the conversion device 100 is connected to both the signal source device 103 and the external device 102, then at step S308, the conversion device 100 reads the extended display identification data of the external device 102. At step S309, based on the information (e.g., resolution, vendor name and serial number) of the extended display identification data of the external device 102, the conversion device 100 determines whether the memory module 140 includes any records of the external device 102 (e.g., previously stored analysis log information).

If it is determined that a record exists at step S309, then at step S310, the conversion device 100 uses the previously recorded version as the version of the connection interface 104 of the external device 102. At step S318, the conversion device 100 integrates the previously recorded extended display identification data of the external device 102 with one of the multiple built-in extended display identification data in the default extended display identification data table 390 that corresponds to the version of the connection interface 104. At step S319, a corresponding extended display identification data is generated through this integration, such that the integrated corresponding extended display identification data matches the video and audio signal receiving capabilities of both the conversion device 100 and the external device 102. At step S320, the conversion device 100 sends a connection signal (e.g., a hot-plugging signal) to the signal source device 103 to notify the signal source device 103 to reconnect to the conversion device 100, thereby obtaining the corresponding extended display identification data.

On the other hand, if it is determined that no record exists at step S309, then at step S311, the conversion device 100 analyzes the contents of the extended display identification data of the external device 102. Based on step S311, at step S312, the conversion device 100 determines whether the extended display identification data of the external device 102 conforms to a first version of the connection interface (e.g., HDMI 2.1).

If the conversion device 100 determines that the extended display identification data of the external device 102 conforms to the first version of the connection interface, then at step S313, the conversion device 100 sets the extended display identification data of the external device 102 as conforming to the first version of the connection interface.

Conversely, if the conversion device 100 determines that the extended display identification data of the external device 102 does not conform to the first version of the connection interface, then at step S314, the conversion device 100 determines whether the contents of the extended display identification data of the external device 102 conforms to a second version of the connection interface (e.g., HDMI 2.0).

If the conversion device 100 determines that the extended display identification data of the external device 102 conforms to the second version of the connection interface, then at step S315, the conversion device 100 sets the extended display identification data of the external device 102 as conforming to the second version of the connection interface.

Conversely, if the conversion device 100 determines that the extended display identification data of the external device 102 does not conform to the second version of the connection interface, then at step S316, the conversion device 100 sets the extended display identification data of the external device 102 as conforming to a third version of the connection interface (e.g., HDMI 1.4).

It should be understood that one of ordinary skill in the art may flexibly add determination steps such as steps S312 to S316 to determine the version of a connection interface to which the extended display identification data of the external device 102 matches based on more versions of various connection interfaces in practice. Accordingly, the conversion device 100 selects a built-in extended display identification data corresponding to the version of the connection interface 104 of the external device 102 from the default extended display identification data table 390, depending on the version of the connection interface 104 of the external device 102.

At step S317, the conversion device 100 stores the analysis log information. The analysis log information may record the version of the connection interface 104 to which the extended display identification data of the external device 102 matches, and may also record the correspondence relationship between the version of the connection interface 104 and the information (e.g., resolution, vendor name and serial number) of the extended display identification data of the external device 102.

On the other hand, at step S318, the conversion device 100 integrates the previously recorded extended display identification data of the external device 102 with one of the multiple built-in extended display identification data in the default extended display identification data table 390 that corresponds to the version of the connection interface 104. At step S319, the corresponding extended display identification data is generated through integration, so that the integrated corresponding extended display identification data matches the video and audio signal receiving capabilities of both the conversion device 100 and the external device 102. At step S320, the conversion device 100 sends a connection signal (e.g., a hot-plugging signal) to the signal source device 103 to notify the signal source device 103 to reconnect to the conversion device 100, thereby obtaining the corresponding extended display identification data.

In summary, the technical solution of the present disclosure has clear advantages and beneficial effects compared with existing technologies. By the conversion device 100 and the methods 200 and 300 for automatically selecting extended display identification data of the present disclosure, the usable extended display identification data (i.e., the corresponding extended display identification data as mentioned above) may be automatically determined, allowing the user to use the conversion device 100 normally without manual settings, so as to avoid complicated user settings and thereby improves the user-friendliness of the conversion device 100.

Although the description provided above is of various embodiments of the disclosure, this is not intended to limit the scope of the disclosure. Those skilled in the art may make various modifications without departing from the spirit and scope of the disclosure. Therefore, the scope of protection of the present disclosure is determined by the following claims.

What is claimed is:

1. A conversion device, comprising:
a transmission module configured to obtain an extended display identification data (EDID) of an external device in response to detecting a connection to the external device;
a processing module electrically connected to the transmission module, configured to determine a version of a connection interface of the external device based on the extended display identification data of the external device, and configured to select a corresponding extended display identification data based on the version of the connection interface of the external device; and
a receiving module electrically connected to the processing module and configured to transmit a connection signal to a signal source device to notify the signal source device to obtain the corresponding extended display identification data.

2. The conversion device of claim 1, wherein the processing module is further configured to analyze contents of the extended display identification data of the external device to determine the version of the connection interface to which the extended display identification data of the external device matches.

3. The conversion device of claim 2, wherein the contents of the extended display identification data of the external device comprises a maximum value of a pixel clock, at least one video and audio function, a high dynamic range imaging information, and a vendor specific data block (VSDB) data or field information.

4. The conversion device of claim 3, wherein the at least one video and audio function comprises an auto low latency mode, quick frame transport, quick media switching, variable refresh rate, and resolution identification.

5. The conversion device of claim 1, further comprising:
a memory module electrically connected to the processing module and configured to store a plurality of built-in extended display identification data, wherein the processing module integrates the extended display identification data of the external device with one of the plurality of built-in extended display identification data to obtain the corresponding extended display identification data that matches video and audio signal reception capabilities of the conversion device and the external device.

6. The conversion device of claim 1, further comprising:
a memory module electrically connected to the processing module and configured to store a plurality of built-in extended display identification data, wherein the processing module selects one of the plurality of built-in extended display identification data corresponding to the version of the connection interface as the corresponding extended display identification data.

7. The conversion device of claim 1, wherein the processing module is further configured to generate a hot-plugging signal as the connection signal and send the hot-plugging signal to the signal source device for notifying the signal source device to reconnect to a first interface of the receiving module to obtain the corresponding extended display identification data.

8. The conversion device of claim 1, wherein the receiving module, the processing module, and the transmission module are integrated within a single system-on-chip (SoC).

9. A method for automatically selecting extended display identification data (EDID), comprising steps:
(A) obtaining an extended display identification data of an external device through a conversion device;
(B) determining a version of a connection interface of the external device through the conversion device based on the extended display identification data of the external device;
(C) selecting a corresponding extended display identification data through the conversion device based on the version of the connection interface of the external device; and
(D) notifying a signal source device through the conversion device to obtain the corresponding extended display identification data.

10. The method for automatically selecting extended display identification data of claim 9, wherein the step (B) comprises:
analyzing, through the conversion device, a maximum value of a pixel clock, at least one video and audio function, a high dynamic range imaging information, and a vendor specific data block (VSDB) data or field information of the extended display identification data of the external device to determine the version of the connection interface to which the extended display identification data of the external device matches.

11. The method for automatically selecting extended display identification data of claim 10, wherein the at least one video and audio function comprises an auto low latency mode, quick frame transport, quick media switching, variable refresh rate, and resolution identification.

12. The method for automatically selecting extended display identification data of claim 9, wherein the step (C) comprises:
intersecting, through the conversion device, the extended display identification data of the external device with one of a plurality of built-in extended display identification data corresponding to the version of the connection interface to obtain the corresponding extended display identification data that matches video and audio signal reception capabilities of the conversion device and the external device.

13. The method for automatically selecting extended display identification data of claim 12, wherein the step (C) further comprises:
pre-storing a default extended display identification data table, wherein the default extended display identification data table records the plurality of built-in extended display identification data corresponding to a plurality of versions of at least one connection interface.

14. The method for automatically selecting extended display identification data of claim 9, wherein the step (C) comprises:
selecting, through the conversion device, one of a plurality of built-in extended display identification data corresponding to the version of the connection interface as the corresponding extended display identification data.

15. The method for automatically selecting extended display identification data of claim 14, wherein the step (C) further comprises:
pre-storing a default extended display identification data table, wherein the default extended display identification data table records the plurality of built-in extended display identification data corresponding to a plurality of versions of at least one connection interface.

16. The method for automatically selecting extended display identification data of claim 9, wherein the step (D) comprises:
sending a hot-plugging signal to the signal source device through the conversion device for notifying the signal source device to reconnect to the conversion device to obtain the corresponding extended display identification data.
